(19) United States
(12) Patent Application Publication
(10) Pub. No.: US 2003/0073369 A1
(43) Pub. Date: Apr. 17, 2003

(54) Structure for protecting compact disc being played on compact disc drive

(76) Inventor: Hsi Jen Chen, Ren-Wuu Shiang (TW)

Correspondence Address: Raymond Yat Chiu Chan, 516 San Luis Rey Road, Arcadia, CA, 91007, US

(21) Appl. No.: 09/738,033

(22) Filed: Dec. 13, 2000

(30) Foreign Application Priority Data
Dec. 27, 1999 (TW) 088222617
Dec. 30, 1999 (TW) 088123351

(51) Int. Cl. B32B 5/16; B32B 9/00; B32B 33/00; D04H 1/00; D04H 3/00; D04H 5/00; D04H 13/00

(52) U.S. Cl. 442/394; 428/41.8; 442/327; 428/417

(57) ABSTRACT

A protective mat is formed of nonwoven cloth, a static preventive layer adhered to the underside of the nonwoven cloth, an adhesive layer coated in the underside of the static preventive layer and provided with a releasing paper which is detachably attached to the underside of the adhesive layer. The protective mat is fitted into the compact disc holding area of a compact disc drive for protecting the compact disc from the static interference at the time when the compact disc is being played on the compact disc drive.

### FIELD OF THE INVENTION

The compact disc is a digital disc that is played on a device using a laser beam to read the encoded matter. The compact disc being played on the device is susceptible to the static interference that is brought about by the device in operation. The present invention thus relates generally to a structure providing the compact disc being played with a protection against the static interference, and more particularly to a protective mat for preventing the process of reading the compact disc from being interfered by the static resulting from the operation of the compact disc drive.

### BACKGROUND OF THE INVENTION

As illustrated in FIG. 1, a compact disc drive 10 of the prior art has a platform 11 which is provided with a compact disc holding area 12 and is devoid of a structure for protecting the compact disc being played on the holding area 12 against the interference by the static resulting from the high speed operation of the spindle of the compact disc drive 10. In the course of the high speed reading of the compact disc by a laser head, the compact disc is continuously interfered by the static, thereby resulting in the incomplete reading of the compact disc or even in the deletion. As a result, it is likely that the compact disc drive in question is regarded by its user as being out of order, or the at the compact disc being played is regarded by its user as being damaged.

### SUMMARY OF THE INVENTION

The primary objective of the present invention is to provide a compact disc drive with a means for protecting a compact disc being played on the compact disc drive from being structurally damaged and from being functionally interfered by the static resulting from the operation of the compact disc drive. The protecting means is a mat, which is adhered to the compact disc holding area of the compact disc drive.

It is another objective of the present invention to provide a compact disc drive with a protective mat which is attached to the surface of the platform of the compact disc drive by a magnetic means in place of the adhesive. The magnetic means includes magnetic powders and iron powders. The protective mat may be provided in the underside thereof with the magnetic powders or iron powders, whereas the platform of the compact disc drive is provided thereon with the iron powders or magnetic powders.

### BRIEF DESCRIPTION OF THE DRAWINGS

FIG. 1 is a perspective view of a structure for protecting a compact disc not yet being played on a compact disc drive according to a first preferred embodiment of the present invention.

FIG. 2 is a sectional view taken along section line A-A of FIG. 1.

FIG. 3 is a schemative view of is a protective mat of the present invention disposed on the surface of the platform of a compact disc drive such that a compact disc holding area of the platform is surrounded by the protective mat.

FIG. 4 is a sectional view of a structure for protecting a compact disc being played on a compact disc drive, along section line B-B of FIG. 3, according to the above first preferred embodiment of the present invention.

FIG. 5 is a sectional view of a structure for protecting a compact disc being played on a compact disc drive, which is coated with a layer of a thermochromic material according to the above first preferred embodiment of the present invention.

FIG. 6 is a sectional schematic view of a structure for protecting a compact disc being played on a compact disc drive according to a second preferred embodiment of the present invention.

FIG. 7 is a schemative view of is a protective mat of the present invention disposed on the surface of the platform of a compact disc drive such that a compact disc holding area of the platform is surrounded by the protective mat according to the second preferred embodiment of the present invention.

FIG. 8 is a sectional schematic view of a structure for protecting a compact disc being played on a compact disc drive according to a third preferred embodiment of the present invention.

### DETAILED DESCRIPTION OF THE PREFERRED EMBODIMENTS

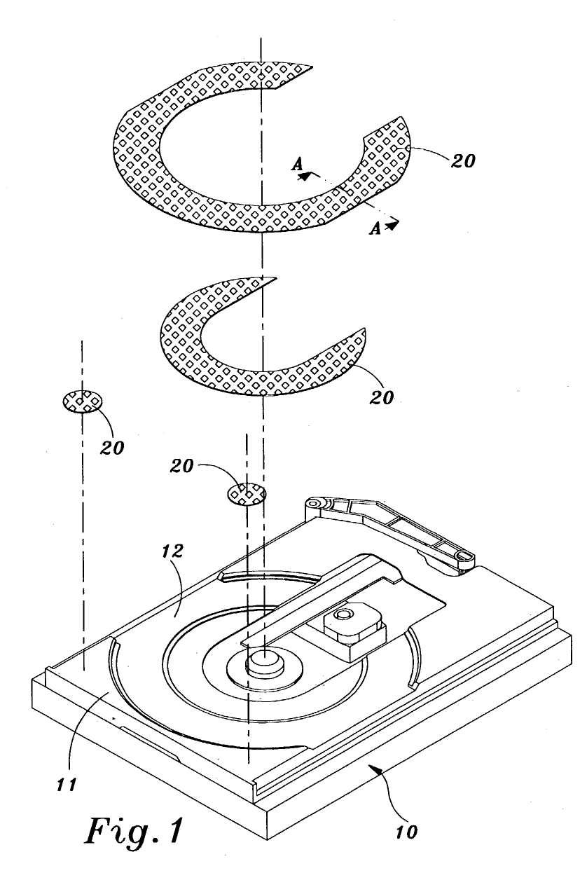

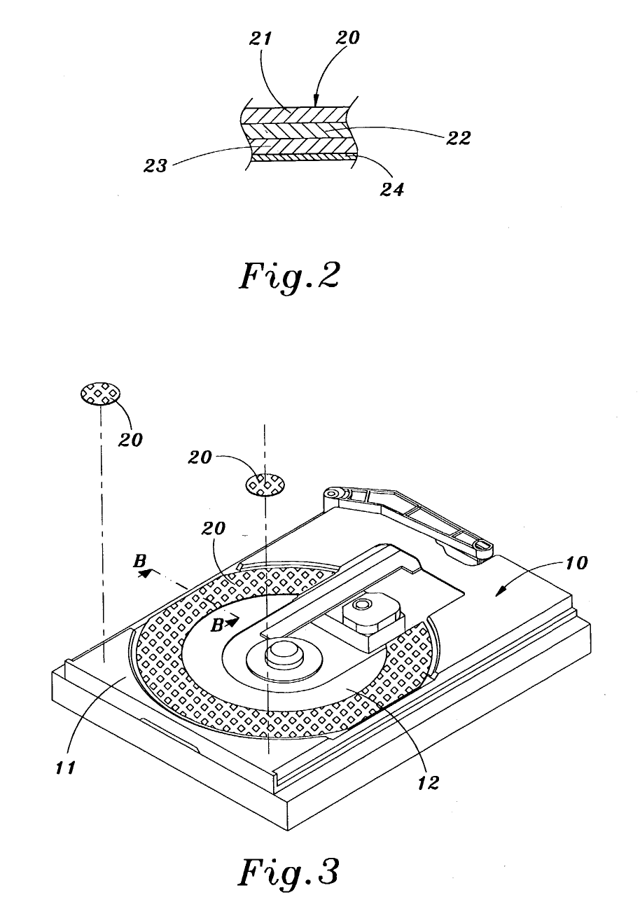

As shown in FIG. 1 and 2, a protective mat 20 embodied in the present invention is intended to be attached to a compact disc holding area 12 of a compact disc platform 11 of a compact disc drive 10. The protective mat 20 is made of a nonwoven cloth 21 of fine fibers and is provided in the underside thereof with a static preventive film 22 which is in turn provided in the underside thereof with an adhesive layer 23. The adhesive layer 23 is detachably shielded by a releasing paper 24.

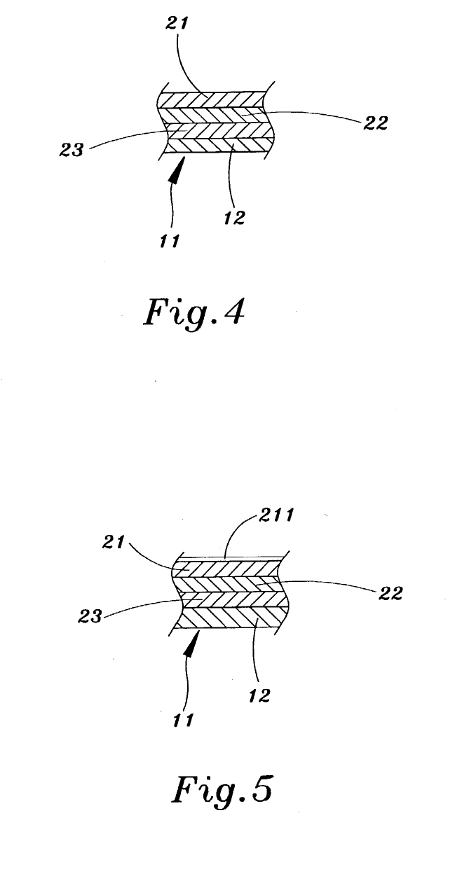

As illustrated in FIGS. 3 and 4, the protective mat 20 of the present invention can be easily attached to the compact disc drive 10 by removing first the releasing paper 24 so as to expose the adhesive layer 23, which is directly adhered to the compact disc holding area 12. A compact disc is placed on the protective mat 20. As the compact disc drive 10 is started, the compact disc is raised by a spindle to facilitate the reading of the compact disc. The encoded surface of the compact disc is protected by the soft nonwoven cloth 21 of the protective mat 20 of the present invention, provided that the compact disc is accidentally impacted in the course of the reading of the compact disc. In addition, the protective mat 20 serves to provide the compact disc with the protection against the static that is brought about on the surface of the compact disc platform 11 of the disc drive 10. The static may be brought about in the interior of the disc drive 10 and is then transmitted to the surface of the compact disc platform 11. In addition, the provide the compact mat 20 of the present invention works to provide the compact disc with protection against the magnetic field. In other words, the encoded surface of the compact disc is free from the static or magnetic field, thanks to the protective mat 20 of the present invention.

As shown in FIG. 5, the nonwoven cloth 21 of the protective mat 20 of the present invention is provided on the surface thereof with a thermochromic coating 211, which enables a user of the compact disc drive 10 to tell easily by the naked eyes of the user if the replacement of the protective mat 20 is called for.

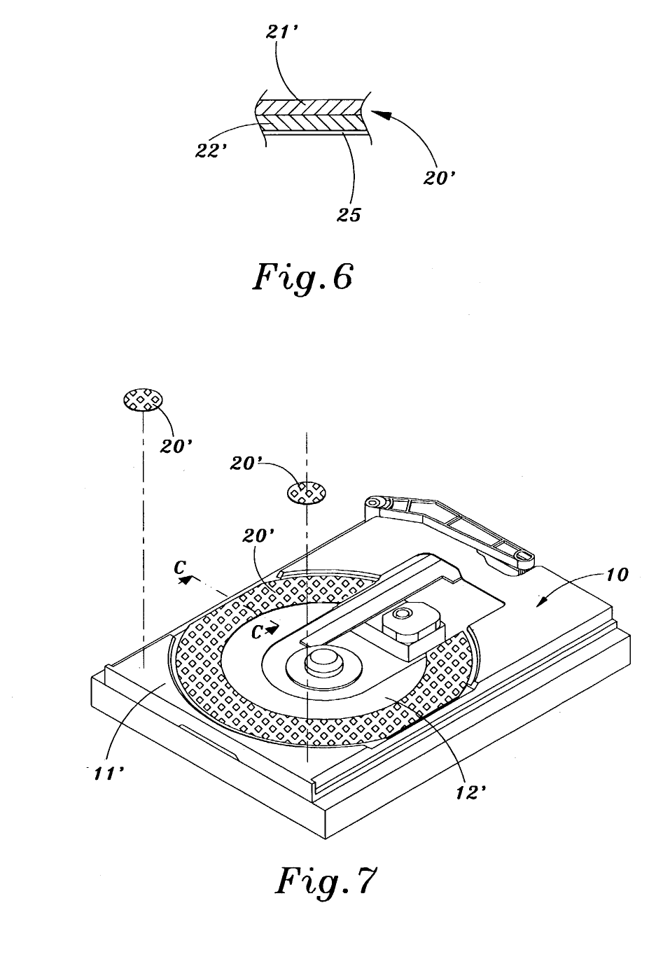

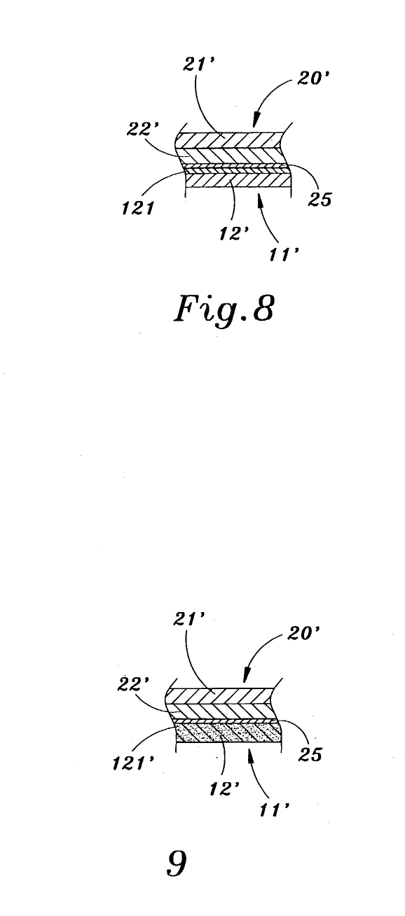

As shown in FIG. 6, FIG. 7, and FIG. 8 a protective mat 20′ of the second preferred embodiment of the present invention is basically similar in construction to the protective mat 20 of the first preferred embodiment described above, except that the protective mat 20′ is provided in the underside of the static preventive film 22′ thereof with a magnetic powder or iron powder layer 25, and that the surface of the compact disc bolding area 12′ is provide with an iron powder or magnetic powder layer 121. The protective mat 20′ is thus attached to the compact disc holding area 12′ by means of the magnetic attraction. The worn-out protective mat 20′ can be easily removed from the compact disc holding area 12′ by holding the edge of the protective mat 20′ with fingers and then lifting the protective mat 20′ away from the surface of the compact disc holding area 12′.

As shown in FIG. 9, a compact disc platform 11′ of a third preferred embodiment of the present invention is made of a material by injection molding. The material contains the magnetic powder or iron powder 121′. As a result, the compact disc platform 11′ and the compact disc holding area 12′ are provided with a power to attract or to be attracted. The protective mat 20′ is provided in the underside thereof with the magnetic powder or iron powder layer 25, thereby enabling the protective mat 20′ to be easily disposed in the compact disc holding area 12′ of the compact disc platform 11′. The protective mat 20′ is easy to use and is highly competitive in the market place.

What is claimed is:

1. A structure for protecting a compact disc being played on a compact disc drive, comprising:
a nonwoven cloth of fine fibers that is shaped to fit into the compact disc holding area of the compact disc drive;
a static preventive film is provided in the underside of said nonwoven cloth;
an adhesive layer which is in turn provided in the underside of said static preventive film; and
a releasing paper is detachably attached in the underside of said adhesive layer.

2. A structure for protecting a compact disc being played on a compact disc drive, as recited in claim 1, wherein said nonwoven cloth of said protective mat is provided in the upper side thereof with a thermochromic coating.

3. A structure for protecting a compact disc being played on a compact disc drive, comprising:
a nonwoven cloth of fine fibers that is shaped to fit into the compact disc holding area of the compact disc drive;
a static preventive film is provided in the underside of said nonwoven cloth;
a magnetic powder layer is coated in the underside of said static preventive film; and
a compact disc holding area is coated with an iron powder layer.

4. A structure for protecting a compact disc being played on a compact disc drive, as recited in claim 3, wherein said static preventive film is coated in the underside thereof with an iron powder layer, and said compact disc holding area is coated with a magnetic power layer.

5. A structure for protecting a compact disc being played on a compact disc drive, as recited in claim 3, wherein said compact disc holding area is made of a material containing the iron powder.

6. A structure for protecting a compact disc being played on a compact disc drive, as recited in claim 4, wherein said compact disc holding area is made of a material containing the magnetic powder.
